(19) United States
(12) Patent Application Publication
(10) Pub. No.: US 2015/0323141 A1
(43) Pub. Date: Nov. 12, 2015

(54) OPTICAL COMPONENT

(71) Applicant: I-CHIUN PRECISION INDUSTRY CO., LTD., New Taipei City (TW)

(72) Inventors: Wan-Shun CHOU, New Taipei City (TW); Ming-Xian LIN, New Taipei City (TW)

(73) Assignee: I-CHIUN PRECISION INDUSTRY CO., LTD., New Taipei City (TW)

(21) Appl. No.: 14/271,684

(22) Filed: May 7, 2014

(51) Int. Cl. F21K 99/00; F21V 5/04

(52) U.S. Cl. CPC F21K 9/50; F21V 5/04; F21V 5/043

(57) ABSTRACT

An optical component includes a light-emitting surface and a bottom surface opposite to the light-emitting surface. The light-emitting surface and the bottom surface cooperatively form a negative lens portion, two first positive lens portions, and two second positive lens portions. The first positive lens portions and the second positive lens portions surround the negative lens portion and arranged in a stagger manner. The first positive lens portion have a first curvature, the second position lens portion have a second curvature smaller larger than the first curvature.

### BACKGROUND OF THE INVENTION

1. Field of the Invention

The present invention relates to an optical component, and in particular to an optical lens applied to street lamp.

2. Description of Related Art

A light emitting diode (LED) is a kind of semiconductor device, which exploits the property of direct-bandgap semiconductor material to convert electric energy into light energy efficiently and has advantages of long lifetime, high stability and low power consumption and is developed to replace the traditional non-directivity light tube and incandescent lamp.

However, in the particular use, since the dimensions of a single LED chip are extremely small, the light intensity can be quite high within an adjacent small area around the LED chip. That may cause discomfort to the human eye when directly viewing the LED chip.

Therefore, in practical application, at least one optical component is often provided into the LED chip for improving the uniform illumination and solving the above-mentioned problem of ultra-high light intensity area around the LED chip. In some particular applications, the optical component can further be designed in shape and size to adjust the distribution of illuminating intensity.

As to the applications of street lamps, the light emitted from street lamps illuminant road surface at night for vehicle drivers to have clear sights and ensure the driving safety. Therefore, illumination distribution of tradition street lamps has peek value at 60 degrees away form both sides of perpendicular direction to provide a better uniformity of the illumination distribution on the roads. In general, the street lamps are usually arranged at intervals along the roadside and each of them has a lamp post standing on the ground and a lamp holder at the top end of the lamp post. The lamp holder should be set inclined upwardly in order to illuminant toward the middle of the road for providing better uniformity of the illumination distribution. However, such a configuration may lead to a negative influence. The upwardly inclined lamp holder may increase the possibility that the light source in the lamp holder may be directly viewed by the human eye thus cause discomfort and blurred vision. And the above-mentioned situation will be worse when the LEDs are used as light source in the street lamps, since the LED chip has higher directness than those of other conventional light sources.

### SUMMARY OF THE INVENTION

The object of the present invention is to provide an optical component, capable of redirecting the illumination distribution and applied to roadside illumination.

Accordingly, the present invention provides an optical component used for redirection illumination distribution of light emitted form light emitted diode (LED). The optical component comprises a light-emitting surface and a bottom surface opposite to the light-emitting surface, the light-emitting surface and the bottom surface cooperatively form a negative lens portion, two first positive lens portions, and two second positive lens portions. The first positive lens portions and the second positive lens portions surround the negative lens portion in a stagger manner. The first positive lens portions have a first curvature, and the second positive lens have a second curvature larger than the first curvature.

In an embodiment of the present invention, the optical component further comprises a lateral surface connected to the bottom surface and the light-emitting surface.

In an embodiment of the present invention, the bottom surface defines a cavity concave toward the light-emitting surface and correspondingly arranged below the negative lens portion.

In an embodiment of the present invention, in a sectional view of the cavity, the cavity is bullet shape.

In an embodiment of the present invention, in a sectional view of the cavity, the cavity comprises a first segment and a second segment connected to the first segment, the second segment is close to the light-emitting surface, and the curvature of the first segment is larger than that of the second segment.

In an embodiment of the present invention, the bottom surface forms two convex columns protruding outwardly and opposite to light-emitting surface.

In an embodiment of the present invention, the convex columns are correspondingly arranged below the first positive lens portions.

In an embodiment of the present invention, the convex columns are cylinders.

In an embodiment of the present invention, in a top view of the optical component, the bottom surface is substantially rectangular.

In an embodiment of the present invention, the optical component is in one-piece form or integrally-formed.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic view of an optical component of the present invention;

FIG. 2 is another schematic view of the optical component of the present invention;

FIG. 3 shows a top view of the optical component of the present invention;

FIG. 4 shows a bottom view of the optical component of the present invention;

FIG. 5 shows a sectional view of the optical component of the present invention;

FIG. 6 shows another sectional view of the optical component of the present invention; and

FIG. 7 is a schematic view of the illumination intensity distribution of the optical component of the present invention.

### DETAILED DESCRIPTION OF THE INVENTION

A preferred embodiment of the present invention will be described with reference to the drawings.

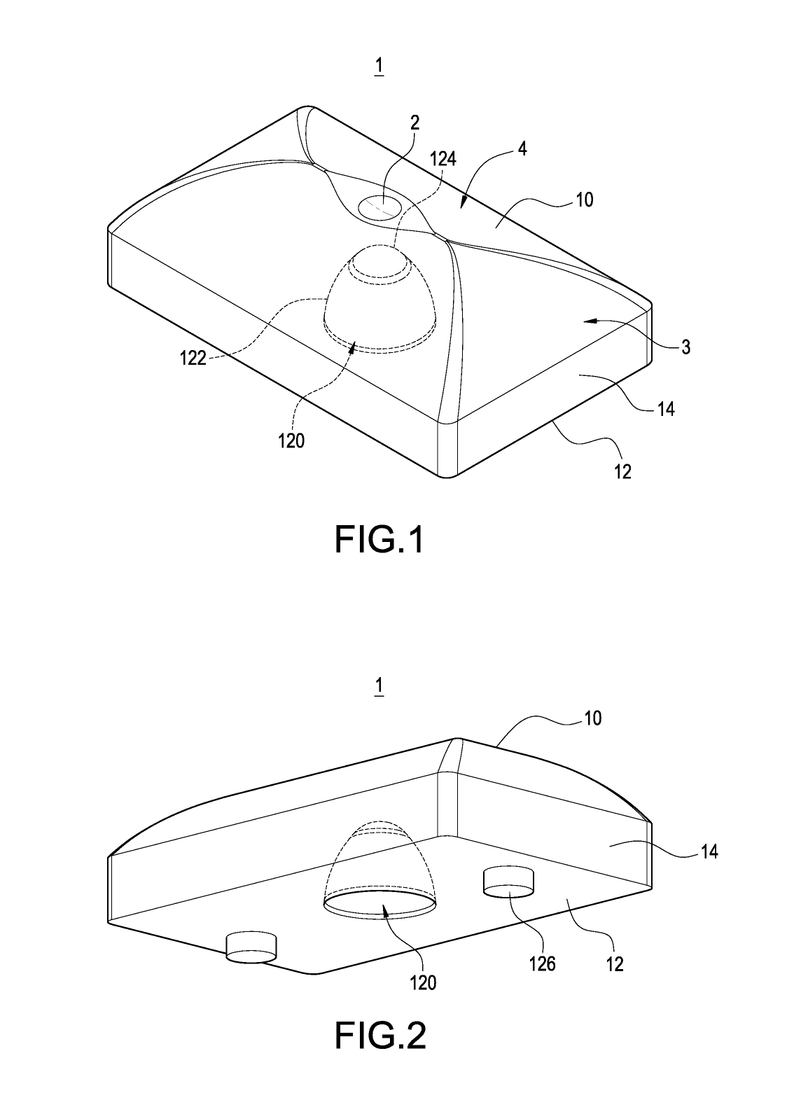

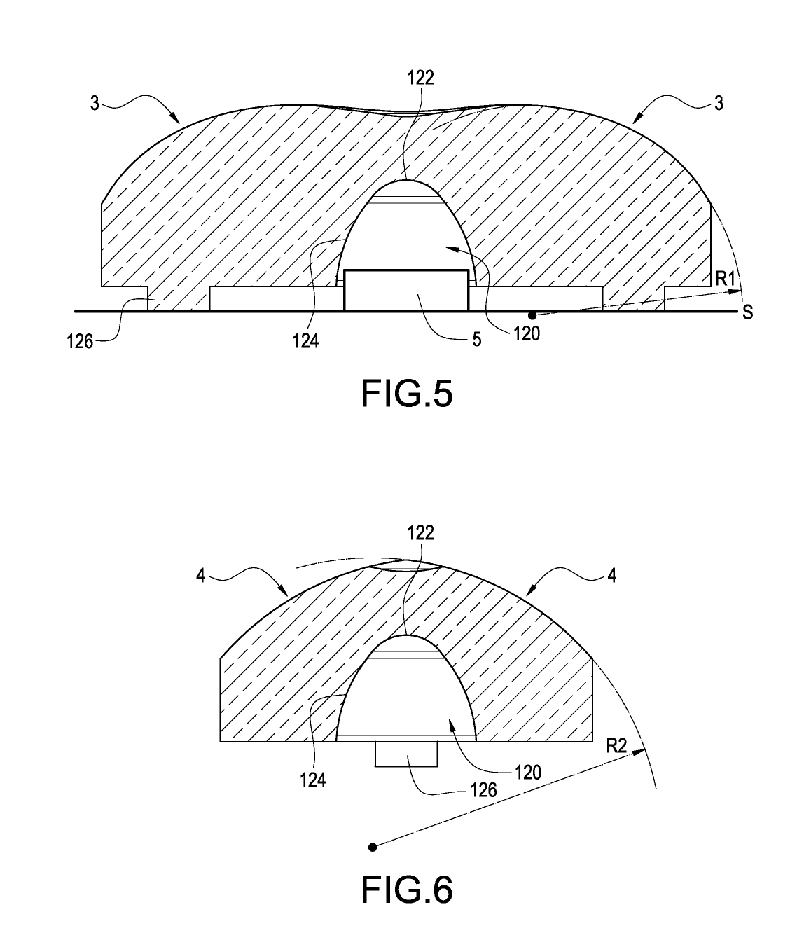

Reference is made to FIG. 1 and FIG. 2, which are schematic views of the optical component of the present invention. The optical component 1 is used for adjusting illumination intensity distribution of light emitted form a light emitting diode (LED) 5 (as shown in FIG. 5). The optical component 1 has an optical axis coincided with a central axis of the optical axis thereof.

A profile of the optical component 1 is substantially rectangular. The optical component 1 is made of transmissive resin, such as epoxy, silicone, glass, or mixtures of the material mentioned above by injection or molding. In preferably, the optical component 1 is in one-piece form or integrally-formed. The optical component 1 includes a light-emitting surface 10, a bottom surface 12 opposite to the light-emitting surface 10, and a lateral surface 14 connected to the light-emitting surface 10 and the bottom surface 12.

The light-emitting surface 10 and the bottom surface 12 cooperatively form a negative lens portion 2, two first positive lens portions 3, and two second positive lens portions 4. Therefore, light can be diverged when the light passes through the negative lens portion 2, and light can be convergence when the light passes through the first positive lens portions 3 and the second positive lens portions 4. Thus, light passing through the negative lens portion 2 has larger divergent angle (which is relative to light passing through the first positive lens portions 3 and the second positive lens portions 4), and light passing through the first positive lens portions 3 and the second positive lens portions 4 have relatively smaller divergent angles (which is relative to light passing through the negative lens portion 2).

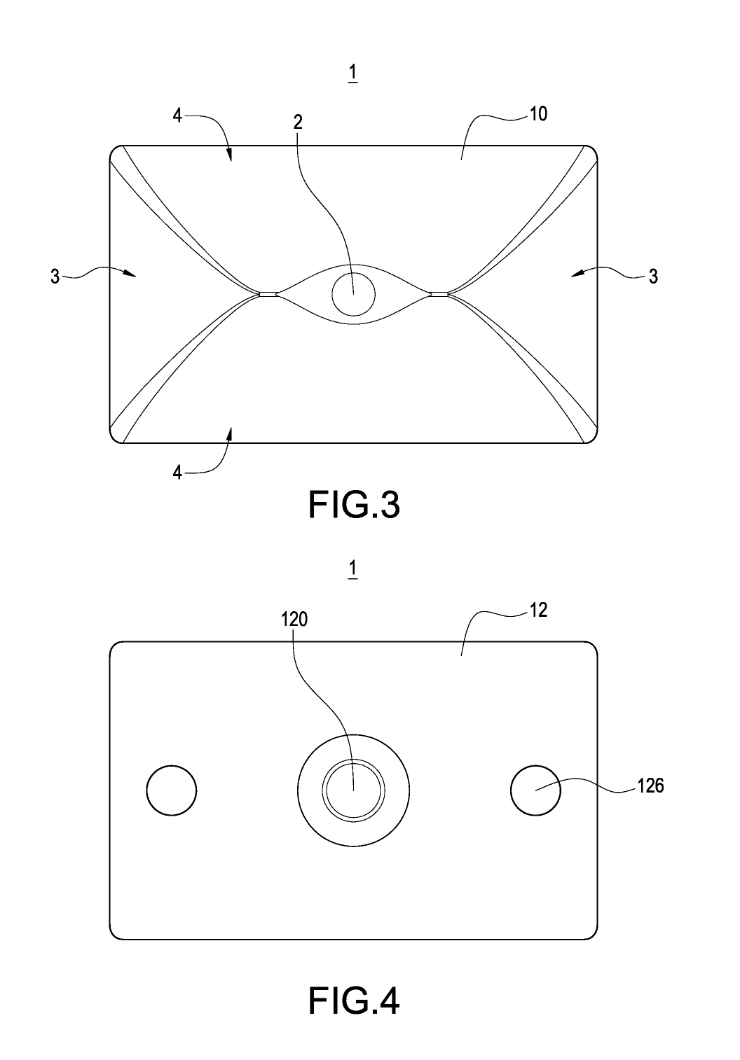

Reference is made to FIG. 3, which shows a top view of the optical component of the present invention. In the top view, the optical component 1 is substantially rectangular. The first positive lens portions 3 and the second positive lens portions 4 surround the negative lens portion 2 and arranged in a stagger manner. The first positive lens portions 3 have a first radius of curvature R1 (as shown in FIG. 5), and the second positive lens portions 4 have a second radius of curvature R2 (as shown in FIG. 6) larger than the first radius of curvature R1. In other words, the curvature of the first positive lens portions 3 is smaller than that of the second positive lens portion 4. It should be noted that since the second curvature is smaller than the first curvature, refractive angle of light passes through the first positive lens portions 3 is larger than that of light passes through the second positive lens portion 4.

Reference is made to FIG. 4, which shows a bottom view of the optical component of the present invention. In the bottom view, the optical component 1 is substantially rectangular, and in preferably, the optical component 1 is rectangular with chamfering. With refer again to FIG.

5 and FIG. 6, the bottom surface 12 forms a cavity 120 concave toward the light-emitting surface 10. In the sectional view of the cavity 120, a profile of the cavity 120 is of bullet shape. In accurately, the cavity 120 includes a first segment 122 and a second segment 124 connected to the first segment 122. The second segment 124 is close to the light-emitting surface 10. The curvature of the first segment 122 is larger than that of the second segment 124. The cavity 12 is arranged below the negative lens portion 2.

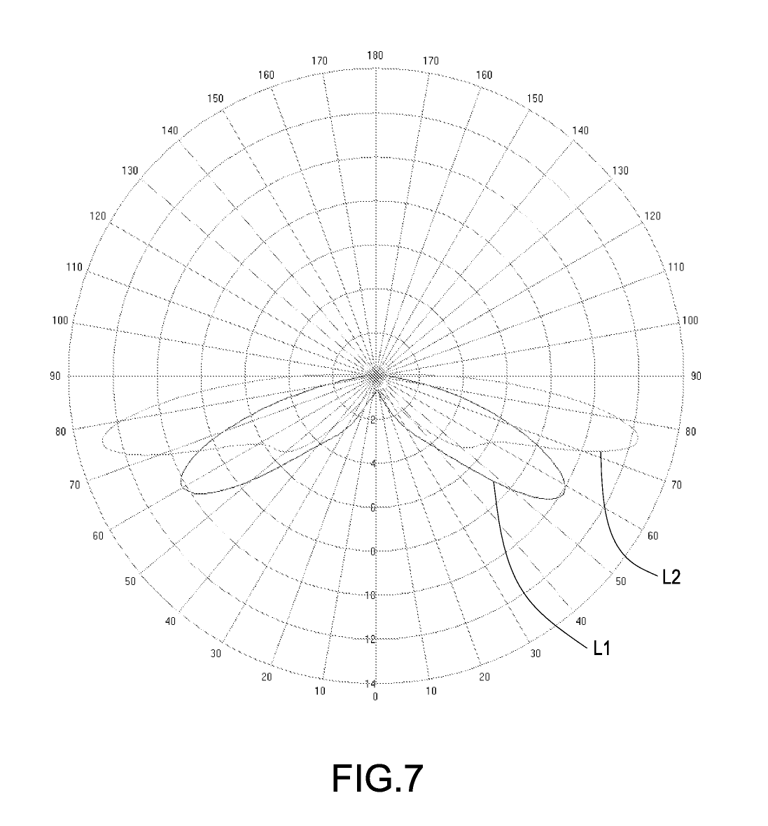

The LED 5 is arranged within the cavity 120 and emits light toward the first segment 122 and the second segment 124. In should be note that, since the curvature of the first segment 122 is larger than that of the second segment 124, refractive angle of light passes through the first segment 122 and enters the optical component 1 is smaller than that of the light passes through the second segment 124 enters the optical component 1. Thus light emitted form the LED 5 can transmit to whole optical component 1, and the illumination intensity distribution of the optical component 1 is shown in FIG. 7. In FIG. 7, the LED 5 and the optical component 1 are arranged at the circle of the center, the LED 5 faces the direction of 0 degree and an optical axis of the LED 5 is coincided with axis of 0 degree, wherein the axis of the LED 5 is a symmetrical axis for light intensity of light emitted from the LED 5 in spatial distribution. Light distribution curves L1 and L2 respectively shows illumination intensity distribution of light passes through the optical component 1 in the directions of 0 degree and 90 degrees. The light distribution curve L1 shows that light emitted form the LED 5 and passing through the optical component 1 in the direction of 0 degree converges in two directions, which are symmetric and each inclining 55 to 60 degrees to the 0 degree. The light distribution curve L2 shows that light emitted form the LED 5 and passing through the optical component 1 in the direction of 90 degrees converges in two directions, which are symmetric and each inclining 70 to 80 degrees to the 0 degree.

Besides, the bottom surface 12 forms two convex columns 126 protruding outwardly and opposite to light-emitting surface 10. Please refer to FIG. 2, the profile of the convex columns 126 are, for example, cylinders, and the convex columns 126 are correspondingly arranged below the first positive lens portions 3, as shown in FIG. 5. The convex columns 126 are used for supporting the optical component 1 on a plane S.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An optical component used for assembling with a light emitting diode (LED), the optical component comprising a light-emitting surface and a bottom surface opposite to the light-emitting surface, the light-emitting surface and the bottom surface cooperatively forming a negative lens portion, two first positive lens portions, and two second positive lens portions, the first positive lens portions and the second positive lens portions surrounding the negative lens portion and arranged in a stagger manner, the first positive lens portions having a first curvature, and the second positive lens portion has a second curvature smaller than the first curvature.

2. The optical component in claim 1, further comprising a lateral surface connected to the bottom surface and the light-emitting surface.

3. The optical component in claim 1, wherein the bottom surface forms a cavity concave toward the light-emitting surface and is arranged below the negative lens portion.

4. The optical component in claim 3, wherein in sectional view of the cavity, the cavity is of bullet shape.

5. The optical component in claim 3, wherein in sectional view of the cavity, the cavity comprises a first segment and a second segment connected to the first segment, the second segment is close to the light-emitting surface, the curvature of the first segment is lager that that of the second segment.

6. The optical component in claim 1, wherein the bottom surface forms a cavity concave toward the light-emitting surface and is arranged below the negative lens portion.

7. The optical component in claim 6, wherein in sectional view of the cavity, the cavity is of bullet shape.

8. The optical component in claim 6, wherein in sectional view of the cavity, the cavity comprises a first segment and a second segment connected to the first segment, the second segment is close to the light-emitting surface, the curvature of the first segment is lager that that of the second segment.

9. The optical component in claim 1, wherein the bottom surface forms two convex columns protruding outwardly and opposite to the light-emitting surface.

10. The optical component in claim 9, wherein the convex columns are arranged below the first positive lens portions.

11. The optical component in claim 10, wherein the convex columns are cylinder.

12. The optical component in claim 1, wherein in top view of the optical component, the bottom surface is rectangular.

13. The optical component in claim 1, wherein the optical component is in one-piece form.
